(19) United States
(12) Patent Application Publication
(10) Pub. No.: US 2024/0193649 A1
(43) Pub. Date: Jun. 13, 2024

(54) TASK AUTOMATION AND SCHEDULING

(71) Applicant: International Business Machines Corporation, Armonk, NY (US)

(72) Inventors: Martin G. Keen, Cary, NC (US); Zachary A. Silverstein, Georgetown, TX (US); Melanie Dauber, Oceanside, NY (US); John M. Ganci, JR., Raleigh, NC (US)

(73) Assignee: International Business Machines Corporation, Armonk, NY (US)

(21) Appl. No.: 18/080,441

(22) Filed: Dec. 13, 2022

(51) Int. Cl. G06Q 30/04; G06F 9/48; G06F 11/32

(52) U.S. Cl. CPC G06Q 30/04; G06F 9/485; G06F 11/327

(57) ABSTRACT

By analyzing activity monitoring data, a task pattern comprising a set of one or more tasks is derived. The task pattern is identified as a candidate task pattern responsive to determining that a completion variability in the task pattern is above a threshold amount. By analyzing performance data of a system used in performing the candidate task pattern, an optimum time at which to perform the candidate task pattern is identified. Responsive to detecting commencement of performance, at a time earlier than the optimum time, the candidate task pattern is delayed. The candidate task pattern is performed at the optimum time.

### BACKGROUND

The present invention relates generally to a method, system, and computer program product for task management. More particularly, the present invention relates to a method, system, and computer program product for task automation and scheduling.

In traditional workflow automation tools, a software developer produces a list of actions to automate a task. The actions are accomplished by interfacing to a back end system, using internal application programming interfaces (APIs) or a scripting language. Robotic process automation (RPA) is a form of business process automation technology in which the list of actions to automate a task is developed by watching a user perform the task in an application, as normal. The RPA system then performs the automated task by mimicking the user's performance of the task in the application. No APIs need to be called, and typically no coding is required.

### SUMMARY

The illustrative embodiments provide a method, system, and computer program product. An embodiment includes a method that derives, by analyzing activity monitoring data, a task pattern, the task pattern comprising a set of one or more tasks. An embodiment identifies the task pattern as a candidate task pattern responsive to determining that a completion variability in the task pattern is above a threshold amount. An embodiment identifies, by analyzing performance data of a system used in performing the candidate task pattern, an optimum time at which to perform the candidate task pattern. An embodiment delays, responsive to detecting commencement of performance, at a time earlier than the optimum time, performance of the candidate task pattern. An embodiment performs, at the optimum time, the candidate task pattern.

An embodiment includes a computer usable program product. The computer usable program product includes one or more computer-readable storage devices, and program instructions stored on at least one of the one or more storage devices.

An embodiment includes a computer system. The computer system includes one or more processors, one or more computer-readable memories, and one or more computer-readable storage devices, and program instructions stored on at least one of the one or more storage devices for execution by at least one of the one or more processors via at least one of the one or more memories.

### BRIEF DESCRIPTION OF THE DRAWINGS

Certain novel features believed characteristic of the invention are set forth in the appended claims. The invention itself, however, as well as a preferred mode of use, further objectives and advantages thereof, will best be understood by reference to the following detailed description of the illustrative embodiments when read in conjunction with the accompanying drawings, wherein:

FIG. 1 depicts an example diagram of a data processing environments in which illustrative embodiments may be implemented;

FIG. 2 depicts a block diagram of an example configuration for task automation and scheduling in accordance with an illustrative embodiment;

FIG. 3 depicts an example of task automation and scheduling in accordance with an illustrative embodiment;

FIG. 4 depicts a continued example of task automation and scheduling in accordance with an illustrative embodiment;

FIG. 5 depicts a flowchart of an example process for task automation and scheduling in accordance with an illustrative embodiment.

### DETAILED DESCRIPTION

The illustrative embodiments recognize that human users perform many tasks during the course of a workday. Some tasks are rote in nature—for example, recording time spent on a project in a time-tracking application—while others require more thought—for example, architecting a computer application or writing a novel. For efficiency, it is desirable to automate as many of the rote tasks human users perform using computer systems as possible, and to perform those tasks as quickly as possible. However, of the tasks human users perform using computer systems, some tasks are more amenable to automation than others. In particular, while tasks that are performed in the same sequence of steps, using consistent input data, are relatively easy to automate, tasks that might be performed using different sequences of steps or require changes in the input data are more difficult. For example, when uploading a video to an online service for processing, transcription, and storage on a video hosting site, a user might need to fill in input data fields such as the video title, description, and categories to which the video should be assigned. Filling in these fields is necessarily different for each video being uploaded, although the basic sequence of uploading the video file and filling in the data remains the same.

The illustrative embodiments also recognize that the tasks human users perform using computer systems can consume variable amounts of time, because of load on a system or the communication network connecting systems, factors affecting system responsiveness, or for other reason. For example, when a new hire starts at a business, one task the business's human resources analyst might perform would be to might be to update the new hire's status in an applicant tracking system and enter the new hire's contact information and payroll data into a central database. Both the applicant tracking system and the central database are hosted remotely from the system the human resources analyst uses to enter the data. Thus, other activity on the remote systems or the network might cause the analyst's task to be serviced more slowly at some times than at other times. If a task is not urgent, it is more efficient to perform the task at a time when the task can be serviced quickly than at a time when the task is serviced more slowly.

Consequently, the illustrative embodiments recognize that, for improved efficiency in task performance, there is a need to automate at least some of the tasks human users perform using computer systems, and if a task is not amenable to automation, at least identify an optimum time for a human user to perform the task.

The illustrative embodiments recognize that the presently available tools or solutions do not address these needs or provide adequate solutions for these needs. The illustrative embodiments used to describe the invention generally address and solve the above-described problems and other problems related to task automation and scheduling.

An embodiment can be implemented as a software application. The application implementing an embodiment can be configured as a modification of an existing task automation or task management system, as a separate application that operates in conjunction with an existing task automation or task management system, a standalone application, or some combination thereof.

Particularly, some illustrative embodiments provide a method that derives a task pattern by analyzing activity monitoring data, identifies the task pattern as a candidate task pattern responsive to determining that a completion variability in the task pattern is above a threshold amount, identifies an optimum time at which to perform the candidate task pattern by analyzing performance data of a system used in performing the candidate task pattern, delays, responsive to detecting commencement of performance, at a time earlier than the optimum time, of the candidate task pattern, and performs the candidate task pattern at the optimum time.

On an opt-in basis, an embodiment monitors a user's activity as the user uses a computer system, or receives data of the user's activity collected by a user monitoring application. For example, one user's activity might be saving updated computer source code in a source code repository, submitting a file to a document management system, or uploading a video to a video sharing site. Techniques are presently available to monitor a user's activity on a system, including process monitoring, file system monitoring, registry monitoring, memory monitoring, network monitoring, database monitoring, event monitoring, and the like. Data of the user's activity is also referred to herein as activity monitoring data.

An embodiment derives a task pattern by analyzing activity monitoring data corresponding to a user. The task pattern includes a set of one or more tasks. For example, one task pattern might include opening, editing, and saving a source code file, rebuilding the application the source code file is a part of, executing an automated test program on the rebuilt application, and saving the updated source code file in a source code repository. Another example task pattern might include saving a video file in a local repository, uploading the video file to an online video repository, filling in data fields of the online video repository that describe the video's title, synopsis, categories, and cast, and marking the video as available for others to view using the online video repository. Techniques to derive a task pattern by analyzing activity monitoring data are presently available. For example, process mining includes a family of techniques (e.g., sequence mining) used in analysis of operational processes based on event logs. An embodiment saves the derived task pattern in a repository of task patterns.

An embodiment also derives completion time statistics for a task pattern. Some non-limiting examples of completion time statistics are the average or mean time taken to complete one or more tasks or the task pattern as a whole, a variance from the mean time taken, the shortest time taken, the longest time taken, the longest time elapsed during a task before a task or task pattern is abandoned incomplete, correlations with other system activity data (e.g., a task might be performed faster or slower at particular times of day, under particular system loads, when particular resources are available), and the like.

An embodiment also derives a sequence variability for the tasks in a task pattern. Sequence variability refers to performance of tasks in a task pattern in a different sequence, or omission or addition of a task in a task pattern. For example, one user might open a document, edit the document, run a spelling check on the document (but not consistently, or only for certain types of documents), then save the editing document.

An embodiment determines whether or not a completion variability of a task pattern is above a threshold amount of variability. The completion variability includes a variability in the time elapsed in performing the task pattern. The larger the range in the time taken to complete a task pattern, the more likely tasks in the task pattern are to involve human decision making, adding to the difficulty of automating the task pattern. The completion variability also includes a sequence variability for the tasks in a task pattern. The higher the sequence variability, the more likely tasks in the task pattern are to involve human decision making, adding to the difficulty of automating the task pattern. If a completion variability of a task pattern is above a threshold amount, an embodiment identifies the task pattern as a candidate task pattern.

An embodiment analyzes performance data of a system used in performing the candidate task pattern, to determine how long one or more tasks in a candidate task pattern take to perform at various times. One embodiment generates and performs one or more exploratory tasks, at various times, and measures how long the exploratory tasks take to complete and other performance data of the system used in performing the candidate task pattern. Exploratory tasks are tasks performed with dummy data that are usable to determine how long corresponding tasks in a candidate task pattern will take. For example, if one of the tasks in a candidate task pattern is to navigate through a series of data entry fields of an online video repository that describe the video's title, synopsis, categories, and cast, a corresponding exploratory task might be to navigate through the same series of data entry fields, filling in dummy data as necessary to reach a next data entry field. One embodiment performs exploratory tasks periodically, for example once per minute or once per hour, as appropriate to the tasks in a candidate task pattern. If there are similar tasks in multiple users' candidate task patterns (e.g., every employee in a video production group has a candidate task pattern in which one of the tasks is to navigate through a series of data entry fields of an online video repository), an embodiment performs only one exploratory task, rather than repeating the same exploratory task for each user's candidate task pattern.

An embodiment uses the determination of how long one or more tasks in a candidate task pattern take to perform at various times to forecast an optimum time or range of time to perform a candidate task pattern or individual tasks within a candidate task pattern. For example, there may be certain times of day during which the responsiveness of a particular application might be faster or slower than other times, and thus an embodiment might forecast one of the faster times as the optimum time. In addition, if there are similar tasks in multiple users' candidate task patterns, an embodiment determines an optimum time for each user, adjusting each user's optimum time so as not to cause the slowness an embodiment is attempting to avoid. For example, if an overall optimum time for a task shared by multiple users' candidate task patterns is between 3 pm and 4 pm, an embodiment might set the optimum time for one user to 3 pm and the optimum time for another user to 3:15 pm.

An embodiment detects commencement of performance, by a user, of a candidate task pattern by analyzing activity monitoring data corresponding to a user. If the current time is earlier than the optimum time for a task in the candidate task pattern, one embodiment alerts the user and suggests that the user delay performance of the task, or the entire candidate task pattern, until the optimum time. For example, if the task is to navigate through a series of data entry fields of an online video repository, the embodiment might alert the user that the responsiveness of the online video repository is slow now, but will be its fastest between three and four this afternoon, and suggest the user perform the task during that time period. If the current time is earlier than the optimum time for a task in the candidate task pattern and the task will take more than a threshold amount or percentage longer than it would at the optimum time, another embodiment alerts the user and suggests that the user delay performance of the task, or the entire candidate task pattern, until the optimum time. However, this embodiment does not suggest a delay if the task will take less than a threshold amount or percentage longer than it would at the optimum time, because a delay will not appreciably improve the user's experience. If the user agrees to delay, at the optimum time an embodiment alerts the user of the task to be performed, provides the user with saved context if appropriate, and monitors the user to determine whether the user actually performs the task. Saved context is data the user was working with when the delay was suggested, such as data of the task itself (e.g., if a video was being uploaded, data about the video), reference materials, and the like. An embodiment uses data of whether or not the user performs the task at the optimum time as input to a learning model to adjust determinations of candidate task patterns, warning thresholds, and other aspects of the user experience.

Another embodiment, instead of suggesting the user delay the task, if the task is amenable to an automation implementation, collects data the user would have used in performing the task and performs the delayed task automatically, at the optimum time. For example, if the task is to navigate through a series of data entry fields of an online video repository, the embodiment might alert the user that the responsiveness of the online video repository is slow now, but will be its fastest at 3 pm this afternoon, collect the data the user would have entered, and perform the data entry and video upload at 3 pm.

The manner of task automation and scheduling described herein is unavailable in the presently available methods in the technological field of endeavor pertaining to automated task performance and management. A method of an embodiment described herein, when implemented to execute on a device or data processing system, comprises substantial advancement of the functionality of that device or data processing system in deriving a task pattern by analyzing activity monitoring data, identifying the task pattern as a candidate task pattern responsive to determining that a completion variability in the task pattern is above a threshold amount, identifying an optimum time at which to perform the candidate task pattern by analyzing performance data of a system used in performing the candidate task pattern, delaying, responsive to detecting commencement of performance, at a time earlier than the optimum time, of the candidate task pattern, and performing the candidate task pattern at the optimum time.

The illustrative embodiments are described with respect to certain types of contents, transmissions, delays, events, climactic events, non-climactic events, periods, forecasts, thresholds, validations, responses, rankings, adjustments, sensors, measurements, devices, data processing systems, environments, components, and applications only as examples. Any specific manifestations of these and other similar artifacts are not intended to be limiting to the invention. Any suitable manifestation of these and other similar artifacts can be selected within the scope of the illustrative embodiments.

Furthermore, the illustrative embodiments may be implemented with respect to any type of data, data source, or access to a data source over a data network. Any type of data storage device may provide the data to an embodiment of the invention, either locally at a data processing system or over a data network, within the scope of the invention. Where an embodiment is described using a mobile device, any type of data storage device suitable for use with the mobile device may provide the data to such embodiment, either locally at the mobile device or over a data network, within the scope of the illustrative embodiments.

The illustrative embodiments are described using specific code, designs, architectures, protocols, layouts, schematics, and tools only as examples and are not limiting to the illustrative embodiments. Furthermore, the illustrative embodiments are described in some instances using particular software, tools, and data processing environments only as an example for the clarity of the description. The illustrative embodiments may be used in conjunction with other comparable or similarly purposed structures, systems, applications, or architectures. For example, other comparable mobile devices, structures, systems, applications, or architectures therefor, may be used in conjunction with such embodiment of the invention within the scope of the invention. An illustrative embodiment may be implemented in hardware, software, or a combination thereof.

The examples in this disclosure are used only for the clarity of the description and are not limiting to the illustrative embodiments. Additional data, operations, actions, tasks, activities, and manipulations will be conceivable from this disclosure and the same are contemplated within the scope of the illustrative embodiments.

Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, reported, and invoiced, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

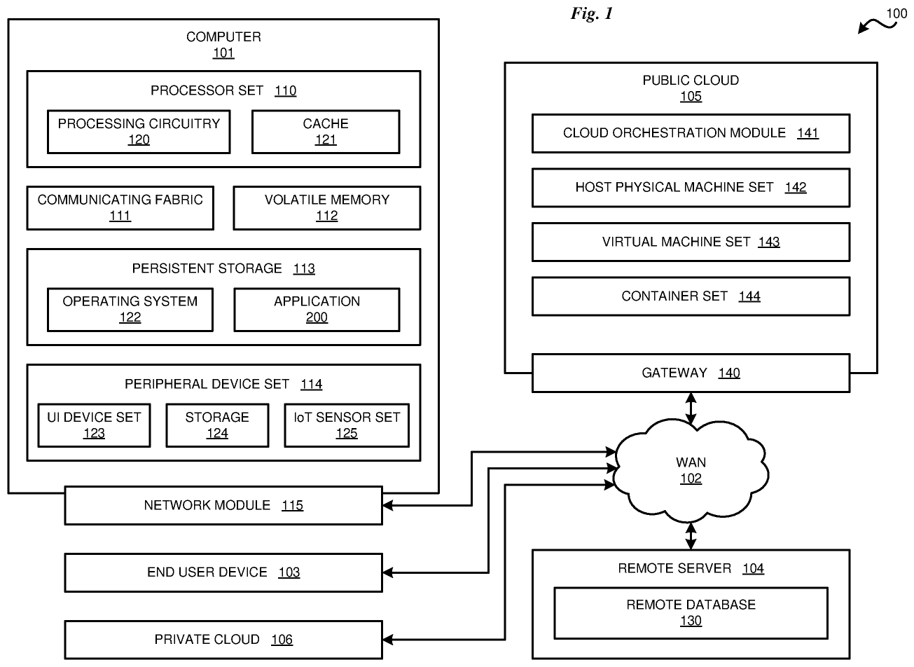

With reference to the figures and in particular with reference to FIG. 1, this figure is an example diagram of a data processing environments in which illustrative embodiments may be implemented. FIG. 1 is only an example and are not intended to assert or imply any limitation with regard to the environments in which different embodiments may be implemented. A particular implementation may make many modifications to the depicted environments based on the following description. FIG. 1 depicts a block diagram of a network of data processing systems in which illustrative embodiments may be implemented. Computing environment 100 contains an example of an environment for the execution of at least some of the computer code involved in performing the inventive methods, such as application 200. Application 200 implements a task automation and scheduling embodiment described herein. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI), device set 123, storage 124, and Internet of Things (IOT) sensor set 125), and network module 115. Remote server 104 includes remote database 130. Public cloud 105 includes gateway 140, cloud orchestration module 141, host physical machine set 142, virtual machine set 143, and container set 144. Application 200 executes in any of computer 101, end user device 103, remote server 104, or a computer in public cloud 105 or private cloud 106 unless expressly disambiguated.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processor set 110 may contain one or more processors and may be implemented using one or more heterogeneous processor systems. A processor in processor set 110 may be a single- or multi-core processor or a graphics processor. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Operating system 122 runs on computer 101. Operating system 122 coordinates and provides control of various components within computer 101. Instructions for operating system 122 are located on storage devices, such as persistent storage 113, and may be loaded into at least one of one or more memories, such as volatile memory 112, for execution by processor set 110.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods of application 200 may be stored in persistent storage 113 and may be loaded into at least one of one or more memories, such as volatile memory 112, for execution by processor set 110. The processes of the illustrative embodiments may be performed by processor set 110 using computer implemented instructions, which may be located in a memory, such as, for example, volatile memory 112, persistent storage 113, or in one or more peripheral devices in peripheral device set 114. Furthermore, in one case, application 200 may be downloaded over WAN 102 from remote server 104, where similar code is stored on a storage device. In another case, application 200 may be downloaded over WAN 102 to remote server 104, where downloaded code is stored on a storage device.

Communication fabric 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in application 200 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, user interface (UI) device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. Internet of Things (IOT) sensor set 125 is made up of sensors that can be used in IoT applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

Wide area network (WAN) 102 is any WAN (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

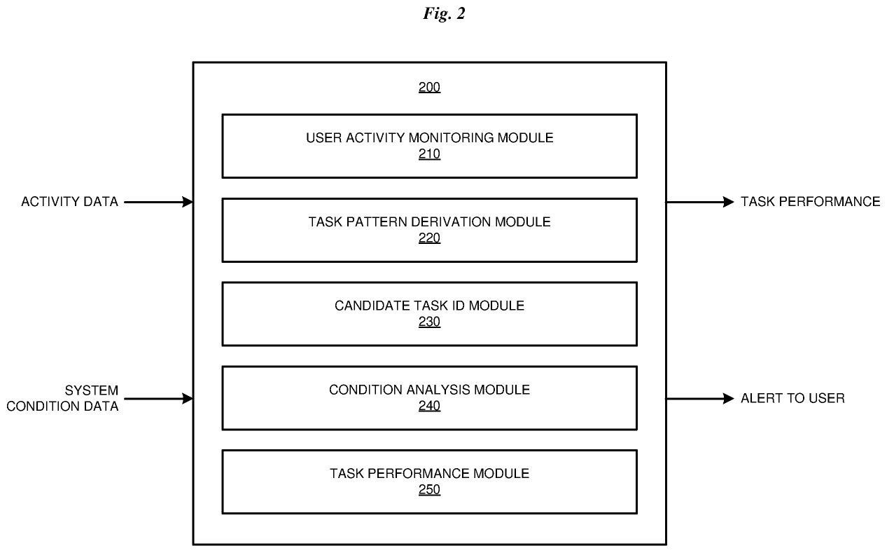

With reference to FIG. 2, this figure depicts a block diagram of an example configuration for task automation and scheduling in accordance with an illustrative embodiment. Application 200 is the same as application 200 in FIG. 1.

On an opt-in basis, user activity monitoring module 210 monitors a user's activity as the user uses a computer system, or receives data of the user's activity collected by a user monitoring application. For example, one user's activity might be saving updated computer source code in a source code repository, submitting a file to a document management system, or uploading a video to a video sharing site. Techniques are presently available to monitor a user's activity on a system, including process monitoring, file system monitoring, registry monitoring, memory monitoring, network monitoring, database monitoring, event monitoring, and the like.

Task pattern derivation module 220 derives a task pattern by analyzing activity monitoring data corresponding to a user. The task pattern includes a set of one or more tasks. For example, one task pattern might include opening, editing, and saving a source code file, rebuilding the application the source code file is a part of, executing an automated test program on the rebuilt application, and saving the updated source code file in a source code repository. Another example task pattern might include saving a video file in a local repository, uploading the video file to an online video repository, filling in data fields of the online video repository that describe the video's title, synopsis, categories, and cast, and marking the video as available for others to view using the online video repository. Techniques to derive a task pattern by analyzing activity monitoring data are presently available. Module 220 saves the derived task pattern in a repository of task patterns.

Module 220 also derives completion time statistics for a task pattern. Some non-limiting examples of completion time statistics are the average or mean time taken to complete one or more tasks or the task pattern as a whole, a variance from the mean time taken, the shortest time taken, the longest time taken, the longest time elapsed during a task before a task or task pattern is abandoned incomplete, correlations with other system activity data (e.g., a task might be performed faster or slower at particular times of day, under particular system loads, when particular resources are available), and the like.

Module 220 also derives a sequence variability for the tasks in a task pattern. Sequence variability refers to performance of tasks in a task pattern in a different sequence, or omission or addition of a task in a task pattern. For example, one user might open a document, edit the document, run a spelling check on the document (but not consistently, or only for certain types of documents), then save the editing document.

Candidate task identification module 230 determines whether or not a completion variability of a task pattern is above a threshold amount of variability. The completion variability includes a variability in the time elapsed in performing the task pattern. The completion variability also includes a sequence variability for the tasks in a task pattern. If a completion variability of a task pattern is above a threshold amount, module 230 identifies the task pattern as a candidate task pattern.

Condition analysis module 240 analyzes performance data of a system used in performing the candidate task pattern, to determine how long one or more tasks in a candidate task pattern take to perform at various times. One implementation of module 240 generates and performs one or more exploratory tasks, at various times, and measures how long the exploratory tasks take to complete and other performance data of the system used in performing the candidate task pattern. Exploratory tasks are tasks performed with dummy data that are usable to determine how long corresponding tasks in a candidate task pattern will take. For example, if one of the tasks in a candidate task pattern is to navigate through a series of data entry fields of an online video repository that describe the video's title, synopsis, categories, and cast, a corresponding exploratory task might be to navigate through the same series of data entry fields, filling in dummy data as necessary to reach a next data entry field. One implementation of module 240 performs exploratory tasks periodically, for example once per minute or once per hour, as appropriate to the tasks in a candidate task pattern. If there are similar tasks in multiple users' candidate task patterns (e.g., every employee in a video production group has a candidate task pattern in which one of the tasks pattern is to navigate through a series of data entry fields of an online video repository), module 240 performs only one exploratory task, rather than repeating the same exploratory task for each user's candidate task pattern.

Module 240 uses the determination of how long one or more tasks in a candidate task pattern take to perform at various times to forecast an optimum time to perform a candidate task pattern or individual tasks within a candidate task pattern. For example, there may be certain times of day during which the responsiveness of a particular application might be faster or slower than other times, and thus an embodiment might forecast one of the faster times as the optimum time. In addition, if there are similar tasks in multiple users' candidate task patterns, module 240 determines an optimum time for each user, adjusting each user's optimum time so as not to cause the slowness an embodiment is attempting to avoid. For example, if an overall optimum time for a task shared by multiple users' candidate task patterns is between 3 pm and 4 pm, module 240 might set the optimum time for one user to 3 pm and the optimum time for another user to 3:15 pm.

Module 240 detects commencement of performance, by a user, of a candidate task pattern by analyzing activity monitoring data corresponding to a user. The activity monitoring data corresponding to a user is provided by user activity monitoring module 210. If the current time is earlier than the optimum time for a task in the candidate task pattern, one implementation of module 240 alerts the user and suggests that the user delay performance of the task, or the entire candidate task pattern, until the optimum time. For example, if the task is to navigate through a series of data entry fields of an online video repository, the implementation might alert the user that the responsiveness of the online video repository is slow now, but will be its fastest between three and four this afternoon, and suggest the user perform the task during that time period. If the current time is earlier than the optimum time for a task in the candidate task pattern and the task will take more than a threshold amount or percentage longer than it would at the optimum time, another implementation of module 240 alerts the user and suggests that the user delay performance of the task, or the entire candidate task pattern, until the optimum time. However, this implementation does not suggest a delay if the task will take less than a threshold amount or percentage longer than it would at the optimum time, because a delay will not appreciably improve the user's experience. If the user agrees to delay, at the optimum time module 240 alerts the user of the task to be performed, provides the user with saved context if appropriate, and monitors the user to determine whether the user actually performs the task. Saved context is data the user was working with when the delay was suggested, such as data of the task itself (e.g., if a video was being uploaded, data about the video), reference materials, and the like. Module 240 uses data of whether or not the user performs the task at the optimum time as input to a learning model to adjust determinations of candidate task patterns, warning thresholds, and other aspects of the user experience.

Task performance module 250, instead of suggesting the user delay the task, if the task is amenable to an automation implementation, collects data the user would have used in performing the task and performs the delayed task automatically, at the optimum time. For example, if the task is to navigate through a series of data entry fields of an online video repository, the implementation might alert the user that the responsiveness of the online video repository is slow now, but will be its fastest at 3 pm this afternoon, collect the data the user would have entered, and perform the data entry and video upload at 3 pm.

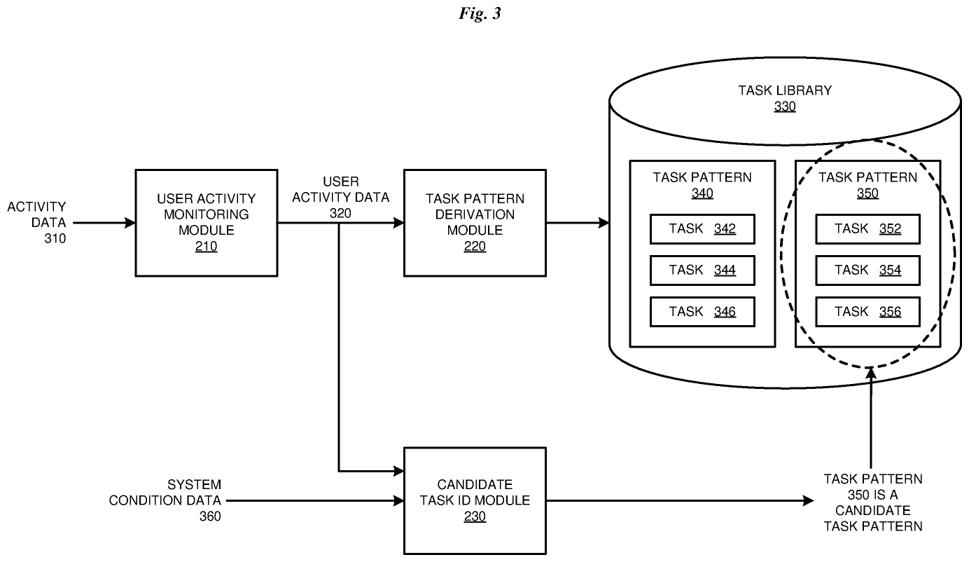

With reference to FIG. 3, this figure depicts an example of task automation and scheduling in accordance with an illustrative embodiment. The example can be executed using application 200 in FIG. 2. User activity monitoring module 210, task pattern derivation module 220, and candidate task identification module 230 are the same as user activity monitoring module 210, task pattern derivation module 220, and candidate task identification module 230 in FIG. 2.

On an opt-in basis, user activity monitoring module 210 monitors activity data 310, generating user activity data 320, data of a particular user's activity. Task pattern derivation module 220 analyzes user activity data 320, deriving task patterns 340 and 350, which are stored in task library 330. Task pattern 340 includes tasks 342, 344, and 346. Task pattern 350 includes tasks 352, 354, and 356. Module 220 also derives completion time statistics for task patterns 340 and 350 (not shown).

Candidate task identification module 230 uses user activity data 320 and system condition data 360 to determines whether or not a completion variability of a task pattern is above a threshold amount of variability. The completion variability includes a variability in the time elapsed in performing the task pattern. The completion variability also includes a sequence variability for the tasks in a task pattern. If a completion variability of a task pattern is above a threshold amount, module 230 identifies the task pattern as a candidate task pattern. Here, task candidate 350 has been identified as a candidate task pattern.

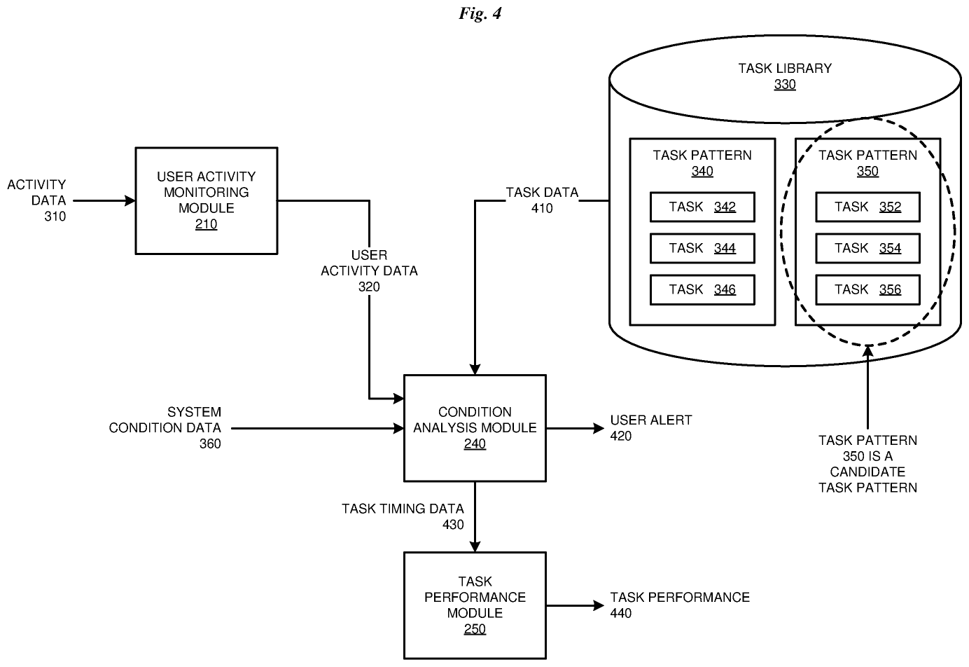

With reference to FIG. 4, this figure depicts a continued example of task automation and scheduling in accordance with an illustrative embodiment. User activity monitoring module 210, condition analysis module 240, and task performance module 250 are the same as user activity monitoring module 210, condition analysis module 240, and task performance module 250 in FIG. 2. Activity data 320, user activity data 320, task library 330, task patterns 340 and 350, tasks 342, 344, 346, 352, 354, and 356, and system condition data 360 are the same as activity data 320, user activity data 320, task library 330, task patterns 340 and 350, tasks 342, 344, 346, 352, 354, and 356, and system condition data 360 in FIG. 3.

On an opt-in basis, user activity monitoring module 210 monitors activity data 310, generating user activity data 320, data of a particular user's activity. Condition analysis module 240 receives task data 410, including data of the tasks in candidate task pattern 350. Condition analysis module 240 analyzes system condition data 360, performance data of a system used in performing tasks in candidate task pattern 350, to determine how long one or more tasks in a candidate task pattern take to perform at various times. One implementation of module 240 generates and performs one or more exploratory tasks, at various times, and measures how long the exploratory tasks take to complete and other performance data of the system used in performing the candidate task pattern.

Module 240 uses the determination of how long one or more tasks in candidate task pattern 350 take to perform at various times to forecast an optimum time to perform candidate task pattern 350 or individual tasks within candidate task pattern 350. Module 240 detects commencement of performance, by a user, of candidate task pattern 350 by analyzing user activity data 320. If the current time is earlier than the optimum time for a task in the candidate task pattern, one implementation of module 240 generates user alert 420, suggesting that the user delay performance of the task, or the entire candidate task pattern, until the optimum time. Module 240 also provides task timing data 430, including the optimum time, to task performance module 250. Task performance module 250, instead of suggesting the user delay the task, if the task is amenable to an automation implementation, collects data the user would have used in performing the task and generates task performance 440, a performance of the delayed task automatically, at the optimum time.

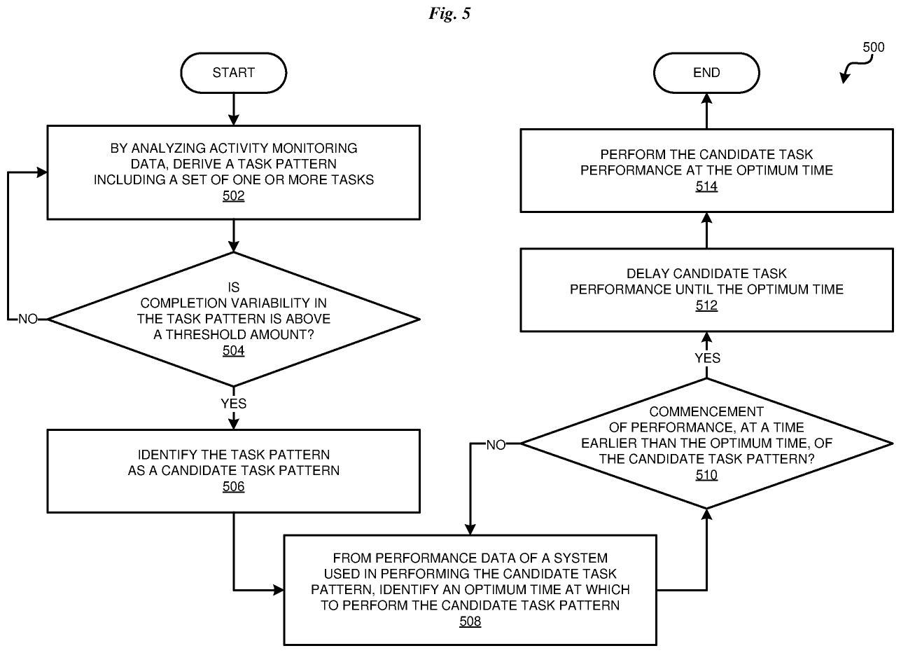

With reference to FIG. 5, this figure depicts a flowchart of an example process for task automation and scheduling in accordance with an illustrative embodiment. Process 500 can be implemented in application 200 in FIG. 2.

In block 502, the application, by analyzing activity monitoring data, derives a task pattern including a set of one or more tasks. In block 504, the application determines whether completion variability in the task pattern is above a threshold amount. If not (“NO” path of block 504), the application returns to block 502. Otherwise (“YES” path of block 504), in block 506, the application identifies the task pattern as a candidate task pattern. In block 508, the application, from performance data of a system used in performing the candidate task pattern, identifies an optimum time at which to perform the candidate task pattern. In block 510, the application determines whether commencement of performance, at a time earlier than the optimum time, of the candidate task pattern has occurred. If not (“NO” path of block 510), the application returns to block 508. Otherwise (“YES” path of block 510), in block 512, the application delays candidate task performance until the optimum time. In block 514, the application performs the candidate task performance at the optimum time. Then the application ends.

Thus, a computer implemented method, system or apparatus, and computer program product are provided in the illustrative embodiments for task automation and scheduling and other related features, functions, or operations. Where an embodiment or a portion thereof is described with respect to a type of device, the computer implemented method, system or apparatus, the computer program product, or a portion thereof, are adapted or configured for use with a suitable and comparable manifestation of that type of device.

Where an embodiment is described as implemented in an application, the delivery of the application in a Software as a Service (SaaS) model is contemplated within the scope of the illustrative embodiments. In a SaaS model, the capability of the application implementing an embodiment is provided to a user by executing the application in a cloud infrastructure. The user can access the application using a variety of client devices through a thin client interface such as a web browser (e.g., web-based e-mail), or other light-weight client-applications. The user does not manage or control the underlying cloud infrastructure including the network, servers, operating systems, or the storage of the cloud infrastructure. In some cases, the user may not even manage or control the capabilities of the SaaS application. In some other cases, the SaaS implementation of the application may permit a possible exception of limited user-specific application configuration settings.

What is claimed is:

1. A computer-implemented method comprising:
deriving, by analyzing activity monitoring data, a task pattern, the task pattern comprising a set of one or more tasks;
identifying the task pattern as a candidate task pattern responsive to determining that a completion variability in the task pattern is above a threshold amount;
identifying, by analyzing performance data of a system used in performing the candidate task pattern, an optimum time at which to perform the candidate task pattern;
delaying, responsive to detecting commencement of performance, at a time earlier than the optimum time, performance of the candidate task pattern; and
performing, at the optimum time, the candidate task pattern.

2. The computer-implemented method of claim 1, further comprising:
deriving, by analyzing the activity monitoring data, a second task pattern;
identifying the second task pattern as a second candidate task pattern responsive to determining that a completion variability in the second task pattern is above the threshold amount;
identifying, by analyzing performance data of a second system used in performing the second candidate task pattern, a second optimum time at which to perform the second candidate task pattern; and
alerting a user, responsive to detecting commencement of performance, at a second time earlier than the second optimum time, of the second candidate task pattern, of the second optimum time.

3. The computer-implemented method of claim 2, further comprising:
alerting, at the second optimum time, the user to perform the second candidate task pattern.

4. The computer-implemented method of claim 1, wherein the completion variability comprises a variability in a time elapsed while performing the task pattern.

5. The computer-implemented method of claim 1, wherein the completion variability comprises a variability in a sequence of the set of tasks in the task pattern.

6. The computer-implemented method of claim 1, wherein the performance data of the system used in performing the candidate task pattern comprises a completion time of an exploratory task performed on the system used in performing the candidate task pattern, the exploratory task corresponding to a task in the candidate task pattern.

7. A computer program product comprising one or more computer readable storage medium, and program instructions collectively stored on the one or more computer readable storage medium, the program instructions executable by a processor to cause the processor to perform operations comprising:
deriving, by analyzing activity monitoring data, a task pattern, the task pattern comprising a set of one or more tasks;
identifying the task pattern as a candidate task pattern responsive to determining that a completion variability in the task pattern is above a threshold amount;
identifying, by analyzing performance data of a system used in performing the candidate task pattern, an optimum time at which to perform the candidate task pattern;
delaying, responsive to detecting commencement of performance, at a time earlier than the optimum time, performance of the candidate task pattern; and
performing, at the optimum time, the candidate task pattern.

8. The computer program product of claim 7, wherein the stored program instructions are stored in a computer readable storage device in a data processing system, and wherein the stored program instructions are transferred over a network from a remote data processing system.

9. The computer program product of claim 7, wherein the stored program instructions are stored in a computer readable storage device in a server data processing system, and wherein the stored program instructions are downloaded in response to a request over a network to a remote data processing system for use in a computer readable storage device associated with the remote data processing system, further comprising:
program instructions to meter use of the program instructions associated with the request; and
program instructions to generate an invoice based on the metered use.

10. The computer program product of claim 7, further comprising:
deriving, by analyzing the activity monitoring data, a second task pattern;
identifying the second task pattern as a second candidate task pattern responsive to determining that a completion variability in the second task pattern is above the threshold amount;
identifying, by analyzing performance data of a second system used in performing the second candidate task pattern, a second optimum time at which to perform the second candidate task pattern; and
alerting a user, responsive to detecting commencement of performance, at a second time earlier than the second optimum time, of the second candidate task pattern, of the second optimum time.

11. The computer program product of claim 10, further comprising:
alerting, at the second optimum time, the user to perform the second candidate task pattern.

12. The computer program product of claim 7, wherein the completion variability comprises a variability in a time elapsed while performing the task pattern.

13. The computer program product of claim 7, wherein the completion variability comprises a variability in a sequence of the set of tasks in the task pattern.

14. The computer program product of claim 7, wherein the performance data of the system used in performing the candidate task pattern comprises a completion time of an exploratory task performed on the system used in performing the candidate task pattern, the exploratory task corresponding to a task in the candidate task pattern.

15. A computer system comprising a processor and one or more computer readable storage media, and program instructions collectively stored on the one or more computer readable storage media, the program instructions executable by the processor to cause the processor to perform operations comprising:
deriving, by analyzing activity monitoring data, a task pattern, the task pattern comprising a set of one or more tasks;
identifying the task pattern as a candidate task pattern responsive to determining that a completion variability in the task pattern is above a threshold amount;
identifying, by analyzing performance data of a system used in performing the candidate task pattern, an optimum time at which to perform the candidate task pattern;
delaying, responsive to detecting commencement of performance, at a time earlier than the optimum time, performance of the candidate task pattern; and
performing, at the optimum time, the candidate task pattern.

16. The computer system of claim 15, further comprising:
deriving, by analyzing the activity monitoring data, a second task pattern;
identifying the second task pattern as a second candidate task pattern responsive to determining that a completion variability in the second task pattern is above the threshold amount;
identifying, by analyzing performance data of a second system used in performing the second candidate task pattern, a second optimum time at which to perform the second candidate task pattern; and
alerting a user, responsive to detecting commencement of performance, at a second time earlier than the second optimum time, of the second candidate task pattern, of the second optimum time.

17. The computer system of claim 16, further comprising:
alerting, at the second optimum time, the user to perform the second candidate task pattern.

18. The computer system of claim 15, wherein the completion variability comprises a variability in a time elapsed while performing the task pattern.

19. The computer system of claim 15, wherein the completion variability comprises a variability in a sequence of the set of tasks in the task pattern.

20. The computer system of claim 15, wherein the performance data of the system used in performing the candidate task pattern comprises a completion time of an exploratory task performed on the system used in performing the candidate task pattern, the exploratory task corresponding to a task in the candidate task pattern.
